(19) United States
(12) Patent Application Publication
(10) Pub. No.: US 2026/0222852 A1
(43) Pub. Date: Jul. 30, 2026

(54) METHODS AND APPARATUSES FOR SUPPORTING RAN ANALYTICS INFORMATION EXPOSURE IN O-RAN

(71) Applicant: Lenovo (Beijing) Limited, Beijing (CN)

(72) Inventors: Shuigen Yang, Shanghai (CN); Mingzeng Dai, Shanghai (CN); Congchi Zhang, Shanghai (CN)

(73) Assignee: Lenovo (Beijing) Limited, Beijing (CN)

(21) Appl. No.: 19/143,239

(22) PCT Filed: Jan. 6, 2023
(86) PCT No.: PCT/CN2023/070979

§ 371 Date: Jun. 25, 2025

(51) Int. Cl. H04W 24/08

(52) U.S. Cl. CPC H04W 24/08

(57) ABSTRACT

The present disclosure relates to methods and apparatuses for supporting radio access network (RAN) analytics information (RAI) exposure in an open-RAN (O-RAN). One embodiment of the present disclosure provides a server, as a producer of RAI, which includes: a first module for transmitting, to a RAN intelligent controller (RIC) platform, a first message(s) indicating at least one supported RAI type; and a second module for generating RAI of a supported RAI type.

### TECHNICAL FIELD

The present disclosure relates to wireless communication, and particularly relates to methods and apparatuses for supporting radio access network (RAN) analytics information (RAI) exposure in an open-RAN (O-RAN).

### BACKGROUND OF THE INVENTION

In an O-RAN, there may be multiple RAI producers that generate RAI and multiple RAI consumers that consume RAI, and these RAI producers and RAI consumers need to share the RAI among them. Therefore, there is a need for RAI exposure in the O-RAN, in other words, sharing the RAI among the multiple RAI producers and the multiple RAI consumers.

Accordingly, it is desirable to provide solutions for supporting RAI exposure in the O-RAN.

### SUMMARY

One embodiment of the present disclosure provides a server, as a producer of RAI, which includes: a first module for transmitting, to a RAN intelligent controller (RIC) platform, a first message(s) indicating at least one supported RAI type; and a second module for generating RAI of a supported RAI type.

In some embodiments, the supported RAI type includes network application or predicted information.

In some embodiments, the first message indicates the at least one supported RAI type, or each first message indicates a single supported RAI type.

In some embodiments, the first message further indicates a dependent RAI type corresponding to the supported RAI type.

In some embodiments, the first message further indicates required data corresponding to the supported RAI type.

In some embodiments, the second module further: receives, from the RIC platform or a server as a consumer of RAI, the required data to generate RAI of the supported RAI type.

In some embodiments, the second module further: transmits, to the RIC platform, the generated RAI of the supported RAI type.

In some embodiments, the second module further: receives, from a server as a consumer of RAI, a second message for RAI of the supported RAI type by an application programming interface (API) invocation; generates the RAI of the supported RAI; and transmits, to a server as the consumer of RAI, the generated RAI of the supported RAI.

In some embodiments, a single API carries the at least one supported RAI type, or each API defines each supported RAI type.

In some embodiments, the API further indicates RAI of a dependent RAI type corresponding to the supported RAI type, required data, or both.

Another embodiment of the present disclosure provides a RIC platform, which includes: a first module for determining at least one supported RAI type; and a second module for transmitting, to a server as a consumer of RAI, a first message(s) indicating the at least one supported RAI type.

In some embodiments, a supported RAI type includes network application or predicted information.

In some embodiments, the first message(s) indicates at least one supported RAI type, or each first message indicates a single supported RAI type.

In some embodiments, the first message(s) includes information of an API for obtaining the supported RAI type, and further includes any of the following: a validity period associated with the RAI; a confidence associated with the RAI; or an identifier of a server, as a producer of RAI of a dependent RAI type.

In some embodiments, determining at least one supported RAI type further comprises: receiving, from a server as a producer of RAI, a second message indicating at least one supported RAI type.

In some embodiments, the second message further indicates a dependent RAI type corresponding to a supported RAI type, required data, or both.

In some embodiments, the second module further: transmits, to a server as a producer of RAI, required data to generate RAI of the supported RAI type; and receives, from the server as a producer of RAI, the generated RAI of the supported RAI type.

In some embodiments, the second module further: receives, from the server as a consumer of RAI, a third message including one or more RAI types, and further including any of the following: time information associated with the RAI of a RAI type; a threshold associated with levels to be reached for the RAI of a RAI type; a level of accuracy associated with the RAI of a RAI type; or a reporting periodicity associated with a notification of the support RAI type.

In some embodiments, the first message(s) is an API discovery response message or a notification message.

In some embodiments, the second module further: receives, from the server as a consumer of RAI, a fourth message requesting for RAI of the supported RAI type by an API invocation; and transmits, to the server as the consumer of RAI, the RAI of the supported RAI.

In some embodiments, a single API carries the at least one supported RAI type, or each API defines each supported RAI type.

In some embodiments, the API further indicates RAI of a dependent RAI type corresponding to the supported RAI type, required data, or both.

Yet another embodiment of the present disclosure provides a server, as a consumer of RAI, which includes: a first module for transmitting, to a RIC platform, a first message for querying a RAI type; and a second module for receiving, from the RIC platform, a second message(s) indicating at least one supported RAI type.

In some embodiments, a supported RAI type includes network application or predicted information.

In some embodiments, the first message is an API discovery request message includes one or more RAI types, and further including any of the following: time information associated with the RAI of a RAI type; a threshold associated with levels to be reached for the RAI of a RAI type; a level of accuracy associated with the RAI corresponding to the one or more RAI types; or a reporting periodicity associated with a notification of the support RAI type.

In some embodiments, the second message(s) includes information of an API for obtaining the supported RAI type, and further includes any of the following: a dependent RAI type of a RAI type; a validity period associated with the RAI; a confidence associated with the RAI; or an identifier of a module that generates RAI for a dependent RAI type.

In some embodiments, the second message(s) indicates the at least one supported RAI type, or each second message indicates a single supported RAI type.

In some embodiments, the first module further: transmits, to a server as a producer of RAI or the RIC platform, a third message for RAI of the supported RAI type by an API invocation; and receives, from the server as the producer of RAI or the RIC platform, the generated RAI of the supported RAI.

In some embodiments, a single API carries the at least one supported RAI type, or each API defines each supported RAI type.

In some embodiments, the API further indicates RAI of a dependent RAI type corresponding to the supported RAI type, required data, or both.

Still another embodiment of the present disclosure provides an apparatus, which includes: a processor; and a storage medium having at least one computer program thereon, the at least one computer program including a plurality of instructions configured to, when executed by the processor, cause the apparatus to: transmit, to a RIC platform, a first message(s) indicating at least one supported RAI type; and generate RAI of a supported RAI type.

Still another embodiment of the present disclosure provides an apparatus, which includes: a processor; and a storage medium having at least one computer program thereon, the at least one computer program including a plurality of instructions configured to, when executed by the processor, cause the apparatus to: determine at least one supported RAI type; and transmit, to a server as a consumer of RAI, a first message(s) indicating the at least one supported RAI type.

Still another embodiment of the present disclosure provides an apparatus, which includes: a processor; and a storage medium having at least one computer program thereon, the at least one computer program including a plurality of instructions configured to, when executed by the processor, cause the apparatus to: transmit, to a RIC platform, a first message for querying a RAI type; and receive, from the RIC platform, a second message(s) indicating at least one supported RAI type.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a part of an O-RAN system according to some embodiments of the present disclosure.

FIGS. 2A-2C illustrate RAI exposure scenarios according to some embodiments of the present disclosure.

FIG. 3 illustrates a flow chart of supporting RAI exposure according to some embodiments of the present disclosure.

FIG. 4 illustrates a flow chart of supporting RAI exposure according to some embodiments of the present disclosure.

FIG. 5 illustrates a method performed by a server as a producer of RAI according to some embodiments of the present disclosure.

FIG. 6 illustrates a method performed by a RIC platform according to some embodiments of the present disclosure.

FIG. 7 illustrates a method performed by a server as a consumer of RAI according to some embodiments of the present disclosure.

FIG. 8 illustrates a simplified block diagram of an apparatus according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as the O-RAN. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

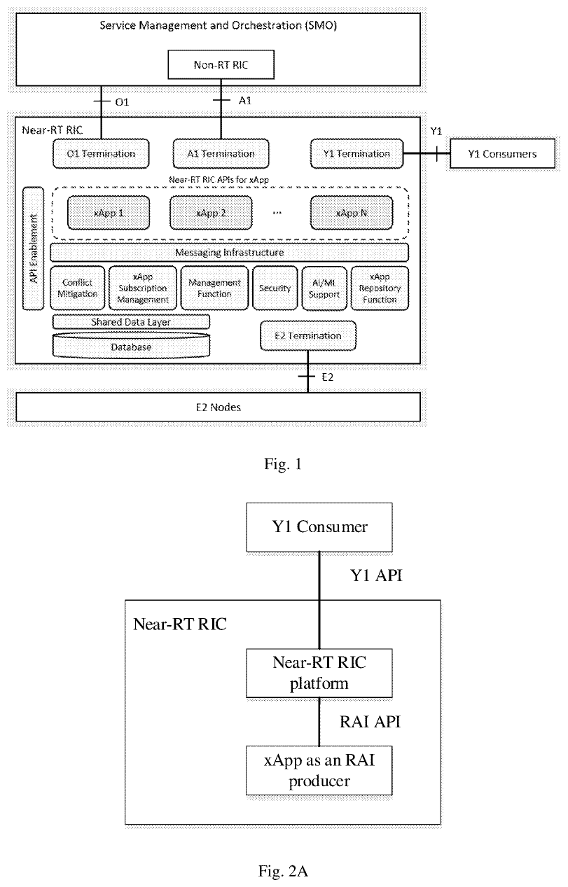

FIG. 1 depicts a part of an O-RAN system according to some embodiments of the present disclosure.

Four components are included, 1) a service management and orchestration (SMO) including a non-real time (RT) RIC, 2) a near-RT RIC, 3) Y1 consumers, and 4) E2 nodes. The non-RT RIC may be an orchestration and automation function described by the O-RAN alliance for non-real time intelligent management of RAN functions. The primary goal of the non-RT RIC is to support non-real-time radio resource management, higher layer procedure optimization, policy optimization in RAN, and providing guidance, parameters, policies and AI models or ML models to support the operation of near-RT RIC functions in the RAN to achieve higher-level non-real-time objectives. The non-RT RIC functions may include service and policy management, RAN analytics and model-training for the near-RT RICs. The non-RT RIC project provides concepts, specifications, architecture and reference implementations as defined and described by the O-RAN alliance architecture.

The near-RT RIC may be a logic function that enables near-real time control and optimization of RAN elements and resources via fine-grained data collection and actions over the E2 interface. The near-RT RIC may be responsible for intelligent edge control of RAN nodes and resources. The near-RT RIC may controls RAN elements and their resources with optimization actions that typically take 10 milliseconds to one second to complete.

The near-RT RIC may include a number of xApps, for example, xApp 1, xApp 2, . . . , xApp N, which may be applications designed to run on the near-RT RIC. Such an application may consist of one or more micro services and at the point of on-boarding may identity which data it consumes and which data it provides. The application may be independent of the near-RT RIC and may be provided by any third party. The application may be independent software plug-in to the near-RT RIC platform to provide functional extensibility to the RAN by any third party.

There are four interfaces, which are 1): interface O1; 2) interface A1; 3) interface Y1; and 4) interface E2. Interface O1 may be an interface between the SMO and O1 termination of the near-RT RIC. Interface Al may be an interface between management entities in SMO framework and the Al termination of the near-RT RIC. The non-RT RIC implementation may communicate with near-RT RIC elements in the RAN via the Al interface. Using the Al interface the non-RT RIC may facilitate the provision of policies for individual user equipment (UE) or groups of UEs; monitor and provide basic feedback on policy state from near-RT RIC; provide enrichment information as required by near-RT RIC; and facilitate ML model training, distribution and inference in cooperation with the near-RT RIC.

Interface Y1 may be an interface between Y1 consumers and the Y1 termination of the near-RT RIC. The Y1 interface may enable RAI exposure from the near-RT RIC to Y1 consumers. Interface E2 may be an interface between E2 nodes and E2 termination of the near-RT RIC. The E2 interface may enable a direct association between xApps and RAN functionalities.

The E2 node may be distributed over a geographic region. In certain embodiments, the E2 node may also be referred to as an access point, an access terminal, a base station, a macro cell, a node-B, an enhanced node B (eNB), a gNB, a home node-B, a relay node, or any device described using other terminology used in the art. The E2 node may be generally part of the O-RAN network that may include one or more controllers communicably coupled to one or more corresponding E2 nodes.

The O-RAN system may be compatible with any type of network that is capable of sending and receiving wireless communication signals. For example, the O-RAN system may be compatible with a wireless communication network, a cellular telephone network, a time division multiple access (TDMA)-based network, a code division multiple access (CDMA)-based network, an orthogonal frequency division multiple access (OFDMA)-based network, an long term evolution (LTE) network, a 3^{rd} Generation Partnership Project (3GPP)-based network, a 3GPP 5G network, a satellite communications network, a high altitude platform network, and/or other communications networks.

In one embodiment, the O-RAN system may be compatible with the 5G new radio (NR) of the 3GPP protocol, wherein the E2 node may transmit data using an orthogonal frequency division multiplexing (OFDM) modulation scheme on the downlink and the UEs 101 transmit data on the uplink using discrete Fourier transform-spread-orthogonal frequency division multiplexing (DFT-S-OFDM) or cyclic prefix-orthogonal frequency division multiplexing (CP-OFDM) scheme. More generally, however, the O-RAN system may implement some other open or proprietary communication protocols, for example, WiMAX, among other protocols.

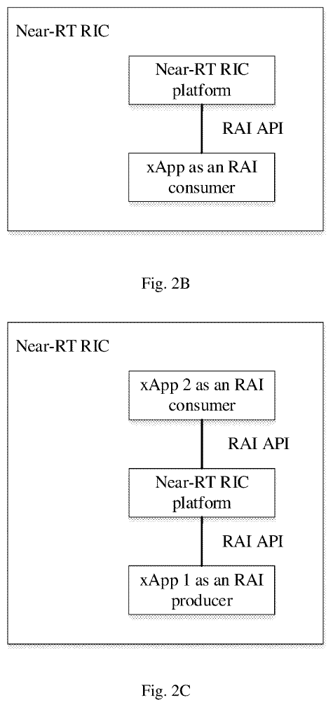

FIGS. 2A-2C illustrate RAI exposure scenarios according to some embodiments of the present disclosure.

There may be the following components in FIGS. 2A-2C, 1): the near-RT RIC platform; 2): a module that may generate the RAI, such as an xApp which may generate the RAI, and may be referred to as an RAI producer, and 3): a model that may consume the RAI, such as a Y1 consumer, or an xApp in the near-RT RIC, or other entities which consume the RAI. It should be noted that the near-RT RIC platform is just an example of a RIC platform, any RIC platform may be applied in the present disclosure.

In FIG. 2A, an xApp in the near-RT RIC may generate the RAI, may function as an RAI producer (or RAI generator), and may provide the RAI to the Y1 consumer via the near-RT RIC platform. This scenario may be referred to as an external exposure scenario.

In FIG. 2B, an xApp in the near-RT RIC may function as an RAI consumer, and the near-RT RIC platform may provide the RAI to the xApp. This scenario may be referred to as an internal exposure scenario.

In FIG. 2C, an xApp, such as xApp 1, in the near-RT RIC may generate the RAI, may function as an RAI procedure, and may provide the RAI to another xApp, such as xApp 2, in the near-RT RIC via the near-RT RIC platform. This scenario may be referred to as an internal exposure scenario.

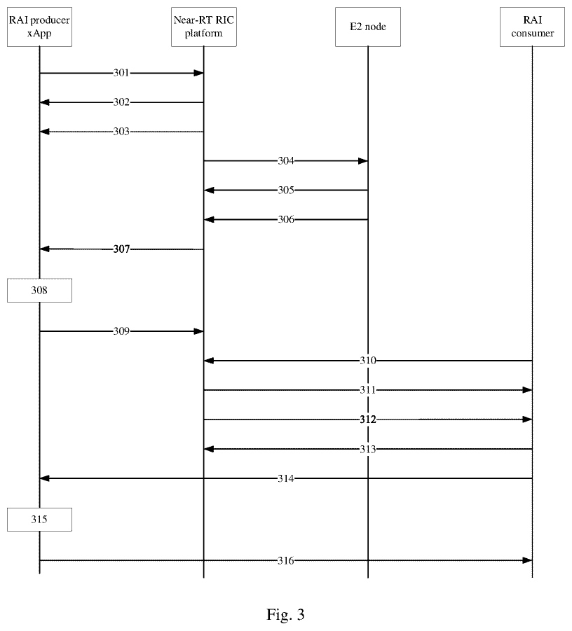

FIG. 3 illustrates a flow chart of supporting RAI exposure according to some embodiments of the present disclosure.

In FIG. 3, four components are included, an RAI producer xApp, a near-RT RIC platform, an E2 node, and an RAI consumer. The RAI producer xApp may produce (or generate) the RAI, and may transmit the produced (or generated) RAI to the near-RT RIC platform, to the RAI consumer via the near-RT RIC platform, or to the RAI consumer directly. The RAI producer xApp may be xApp 1, xApp 2, . . . ,xApp N as depicted in FIG. 1, or any other entities that may produce (or generate) the RAI. In some embodiments, the RAI producer xApp may be a server that includes one or more modules that may perform the functions such as generating the RAI, transmitting the RAI, etc. The RAI consumer may be an Y1 consumer, an xApp in the near-RT RIC (such as xApp 2 as shown in FIG. 2C), or any entity that may consume the RAI. In some embodiments, the RAI consumer may be a server that includes one or more modules that may perform the functions such as consuming the RAI. The RAI consumer may obtain the RAI from the near-RT RIC platform, or from the RAI producer via the near-RT RIC platform, or from the RAI producer directly. It should be noted that the near-RT RIC platform is just an example of a RIC platform, any RIC platform may be applied in the present disclosure, e.g., a non-RT RIC platform. That is, the solutions of the present disclosure may also be performed by any RIC platform.

In operation 301, the RAI producer xApp may transmit a message to the near-RT RIC platform, for example, an xApp registration request message, to initiate the xApp registration procedure.

The message may include at least one supported RAI type, which may be provided by the RAI producer. The supported RAI type may include network application, for example, traffic steering, quality of service (QOS) based resource optimization, RAN slice service level agreement assurance, quality of experience (QoE) optimization, etc. The supported RAI type may include predicted information, such as: the predicted RAN performance, the QoE prediction, the UE trajectory prediction, etc.

In some embodiments, the RAI producer xApp may transmit at least one message, with each message including one supported RAI type. In the case that there are a number (denoted as L for simplicity) of supported RAI types, the RAI producer xApp may transmit L messages, each message including one supported RAI type.

In some other embodiments, the RAI producer xApp may transmit one message including all the supported RAI types, e.g., the L supported RAI types. For example, the message may include a list of L supported RAI types. Alternatively, the message may include an indication, such as a string, which may be used to indicate all the supported RAI types, e.g., the L supported RAI types. The string may include a bitmap, or a bitmask indicating the L supported RAI types. Each value of the bitmap may represent a RAI type. For example, the first bit of the bitmap may represent the QoE prediction, value “0” of the first bit may represent the QoE prediction is not supported, and value “1” of the first bit may represent the QoE prediction is supported. Similarly, the second bit of the bitmap may represent the QoS based resource optimization, etc. Regarding a bitmask, which may include a number of bits, such as two bits, value “00” of the two bits may represent the QoE prediction, and value “01” of the two bits may represent the UE trajectory prediction.

The message may include one or more dependent RAI types for a supported RAI type. The one or more dependent types for the supported RAI type are the RAI types needed for the operation of the RAI producer xApp. For example, for a supported RAI type, denoted as RAI type 1 for simplicity, the dependent RAI types for RAI type 1 may include: 1) dependent RAI type A; and 2) dependent RAI type B. For another supported RAI type, denoted as RAI type 2 for simplicity, the dependent RAI types for RAI type 2 may include: 1) RAI type C; and 2) RAI type D. In this case, the message may include a list including the following:
supported RAI type 1:
   dependent RAI type A;
   dependent RAI type B;
supported RAI type 2:
   dependent RAI type C;
   dependent RAI type D.

The message may include required data for a supported RAI type. The required data for the supported RAI type are needed for the operation of the RAI producer xApp. For example, for a supported RAI type, denoted as RAI type 3 for simplicity, may require data X. For another supported RAI type, denoted as RAI type 4 for simplicity, may require data Y. In this case, the message may include a list including the following:
supported RAI type 3:
   required data X;
supported RAI type 4:
   Required Data Y.

In some embodiments, the message may include one or more dependent RAI types as well as required data for a supported RAI type. The one or more dependent RAI types and the required data for the supported RAI type are needed for the operation of the RAI producer xApp. For example, for a supported RAI type, denoted as RAI type 5 for simplicity, may require: 1) dependent RAI type E; 2) dependent RAI type F; and 3) data M. For another supported RAI type, denoted as RAI type 6 for simplicity, may require: 1) dependent RAI type G; and 2) data N. In this case, the message may include a list including the following:
supported RAI type 5:
   dependent RAI type E;
   dependent RAI type F;
   required data M;
supported RAI type 6:
   dependent RAI type G;
   required data N.

In some embodiments, the message may include no dependent RAI types or required data. For example, for a supported RAI type, denoted as RAI type 7 for simplicity, may require no input data, and the message may include a list including the following:
supported RAI type 7:
   none.

In some embodiments, the RAI producer xApp may need data for RAI generation, and the message may further request for the required data for the RAI generation. The required data may include at least one of the following:
Cell level configuration parameters, e.g., a physical cell identity, neighbour relations and related offsets for measurement, cell reselection and handover.
Cell related measurements, synchronization signal (SS)/physical broadcast channel (PBCH) block related measurements, or slice related measurements, such as downlink or uplink total physical resource block, radio resource control connection number, mean and maximum number of active UEs.
E2 node user plane measurements per UE or per UE group, such as an average downlink or uplink throughput, buffer status information.
UE layer 1 (L1), layer 2 (L2) or layer 3 (L3) measurements, such as reference signal received power (RSRP) measurements, reference signal received quality (RSRQ) measurements, signal to interference plus noise ratio (SINR) measurements, channel quality indicator (CQI) measurements, or modulation and coding scheme (MCS) measurements.
UE context information, such as a UE ID, QoS information, a radio bearer related information, UE capability information.
L3 mobility measurements per cell, per beam or per beam group, such as the number of too early handovers, the number of too late handovers, the number of handovers to a wrong cell;
etc.

In the case that the registration request may be accepted, or may be successfully fulfilled, in operation 302, the near-RT RIC platform may send a success message, such as an xApp registration success message, to the RAI producer xApp. The success message may include the identifier of the RAI producer xApp (referred to as an xApp ID for short), which may be assigned by the near-RT RIC platform.

In the case that the registration request may be rejected, or may not be fulfilled, in operation 303, the near-RT RIC platform may send a failure message, such as an xApp registration failure message, to the RAI producer xApp. The failure message may include a cause value, which may indicate the failure reason why the registration request fails. For example, the failure reason may be that the dependent RAI type(s) is not supported. For example, for supported RAI type 1, it corresponds to dependent RAI type A and dependent RAI type B. It is supposed that the dependent RAI type A may be not supported, therefore, the registration request fails.

In operation 304, the near-RT RIC platform may initiate a procedure, such as a measurement data collection procedure, to collect data from the E2 node. The near-RT RIC platform may send a message, e.g., an RIC subscription request message which indicates the required data. That is, the near-RT RIC platform may request the required data (which may be required by the RAI producer xApp in operation 301, such as required data X) from the E2 node.

In operation 305, the E2 node may transmit a message, e.g., a RIC subscription response message, to the near-RT RIC platform.

In operation 306, the E2 node may transmit a message, e.g., a RIC indication message, to the near-RT RIC platform, which may contain the required data previously requested by the near-RT RIC platform during a successful RIC subscription procedure.

It should be noted that operations 304-306 may be performed before operations 301-303, simultaneously with operations 301-303, or after operations 301-303.

In operation 307, the near-RT RIC platform may send a message, such as an E2 indication message, to the RAI producer xApp. The message may include the required data previously requested by the RAI producer xApp during a successful xApp registration procedure. For example, the required data requested by the RAI producer xApp in operation 301, such as required data X.

In operation 308, the RAI producer xApp may generate the RAI, using artificial intelligence (AI) models, or machine learning (ML) models. The RAI producer xApp may generate the RAI with the collected measurement data (which may include the data received from the near-RT RIC platform in operation 307 and/or other data). In some cases, the RAI producer xApp may generate the RAI without the required data.

Based on different RAI types, the generated RAI may be different.
In one example, the RAI type may be QoE optimization, the generated RAI may be the historical or predicted RAN performance per UE. For instance, the historical or predicted minimum (or maximum, or average) throughput, the historical or predicted minimum (or maximum, or average) latency, the historical or predicted average packet loss rate, or the historical or predicted QoE value.
In another example, the RAI type may be traffic steering, the generated RAI may be the historical or predicted resource status information, such as the historical or predicted downlink (or uplink) total physical resource blocks, the historical or predicted radio resource control connection number, the historical or predicted mean and maximum number of active UEs.
In another example, the RAI type may be QoS based resource optimization, the generated RAI may be the historical or predicted QoS information (e.g., the QoS flow level QoS parameters, the evolved radio access bearer (E-RAB) level QoS parameters) or the historical or predicted radio bearer related information (e.g., flow to data radio bearer (DRB) mapping, established DRB ID).
In another example, the RAI type may be RAN slice service level agreement assurance, the generated RAI may be the historical or predicted per-slice dedicated (or maximum) physical resource block allocation percentages for downlink and uplink, per-slice indication of resource sharing allowance to achieve utilization of unused slice resources by other slice(s), per-slice priority value(s) to achieve scheduling prioritization among slices with different priority value(s).
In another example, the RAI type may be UE trajectory prediction, the generated RAI may be the predicted location of the UE, e.g., the geographical location, the cells the UE will move to.

In operation 309, the RAI producer xApp may send the supported RAI types and the corresponding RAI to the near-RT RIC platform. In some other cases, the RAI producer xApp may not transmit the supported RAI types and the corresponding RAI to the near-RT RIC platform, that is, operation 309 may not be performed. For example, the RAI producer xApp may transmit the supported RAI types and the corresponding RAI to the near-RT RIC platform when a specific request for the supported RAI types and the corresponding RAI is received.

It should be noted that in some embodiments, the RAI may be generated by the near-RT RIC platform instead of the RAI producer xApp, in this case, operations 301-303 and 307-309 may not be performed.

In operation 310, in order to discover one or more RAI APIs available at the near-RT RIC platform, the RAI consumer may send a message, for example, an API discovery request message, to the near-RT RIC platform.

The message may further include at least one of the following:
An identifier of the RAI producer xApp, e.g. an xApp ID of the RAI producer xApp, or an identifier of any RAI producer.
The RAI type(s) indicating the query criteria.
Time information which indicates the latest time the RAI consumer expects to receive the RAI.
An analytics period which indicates the time interval in the future that the RAI should be located. The time interval may be expressed with actual start time and actual end time (e.g., via universal time coordinated (UTC) time). When the start time and the end time are the same value, the RAI may be for a specific time rather than for a time interval.
A threshold which indicates the conditions on the level to be reached for the RAI.
A preferred level of accuracy which indicates the accuracy level of the RAI that the RAI consumer preferred. For example, the preferred level of accuracy may be low, medium, high or highest.

In the case that the near-RT RIC platform may accept the request, e.g., the API discovery request message, in operation 311, it may transmit a message, e.g. a response message (or a success message), to the RAI consumer. The message may also be an API discovery response message.

In one embodiment, the RAI may be provided by the RAI producer xApp, e.g., the RAI may be generated by the RAI producer xApp, the response message may include one or more supported RAI types which may be provided by the RAI producer xApp. The detailed description of the supported RAI types is similar to the supported RAI types as described in operation 301.

In another embodiment, the RAI may be provided (or generated) by the near-RT RIC platform, the response message may include the API ID assigned by the near-RT RIC platform. The RAI generation performed by the near-RT RIC platform is similar to that performed by the RAI producer xApp.

The response message may further include at least one of the following:
A validity period, that is, the RAI may be valid within the time period.
A confidence, or a confidence value; which may indicate the probability assertion of the RAI, i.e., confidence in the RAI.
One or more dependent RAI types for the supported RAI type, that is, the one or more dependent RAI types are needed for normal operation of the xApp. For example, dependent RAI type A and dependent RAI type B are needed for supported RAI type 1.
If the one or more dependent RAI types are included, the message may further include the xApp ID of the RAI producer xApp that could provide the one or more dependent RAI types. In one embodiment, the API ID may be used to indicate the xApp that could provide the one or more dependent RAI types.

In the case that the near-RT RIC platform may reject the request, e.g., the API discovery request message, in operation 312, it may transmit a message (or a response message, or a failure message), to the RAI consumer, for example, an API discovery failure message. The message may include a cause value to indicate the failure reason is that the RAI type is not supported.

In the case that the RAI is provided by the near-RT RIC platform, in operation 313, the RAI consumer may obtain the RAI from the near-RT RIC. More specifically, the RAI consumer may obtain the RAI from the near-RT RIC platform by RAI API invocation.

In some embodiments, each RAI type may correspond to an RAI API, that is, each RAI type is defined as an RAI API. In some other cases, a single RAI API may be used for all RAI types. In still some embodiments, an API may further indicate RAI of a dependent RAI type corresponding to the supported RAI type, required data, or both the supported RAI type and the required data.

Alternatively, in the case that the RAI is provided by the RAI producer xApp, in operation 314, the RAI consumer may obtain the RAI from the RAI producer xApp by RAI API invocation.

Alternatively, the RAI consumer may send a message, such as an indication message, to the RAI producer xApp. The message may include the required data for generating the RAI, a RAI type, or both the required data and the RAI type.

In operation 315, similar as operation 308, the RAI producer xApp may generate the RAI, using the corresponding AI models or ML models with or without required data depending on whether the RAI type requires data.

In operation 316, similar as operation 309, the RAI producer xApp may transmit the RAI and the corresponding supported RAI type to the RAI consumer.

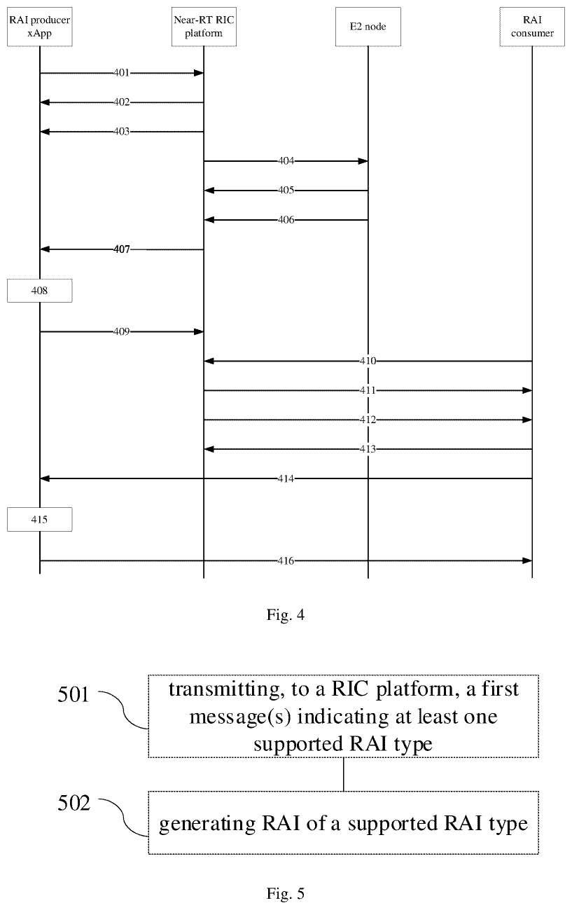

FIG. 4 illustrates a flow chart of supporting RAI exposure according to some embodiments of the present disclosure.

Operations 401-409 are similar to operations 301-309 in FIG. 3, and details are omitted here.

In operation 410, in order to subscribe to the near-RT RIC API related events, the RAI consumer may send a message, for example, an API event subscription request message, to the near-RT RIC platform.

The message may include at least one of the following:
an identifier of the RAI producer xApp, e.g. an xApp ID of the RAI producer xApp, or an identifier of any RAI producer.
the RAI Type(s) indicating the query criteria.
a reporting periodicity, which indicates the periodicity that can be used for reporting the RAI. The reporting periodicity may be an enumerated value, e.g., 500 ms, 1000 ms, or the like.
time information which indicates the latest time the RAI consumer expects to receive the RAI.
an analytics period which indicates the time interval in the future that the RAI should be located. The time interval may be expressed with actual start time and actual end time (e.g., via UTC time). By setting the start time and the end time to the same value, the RAI should be for a specific time rather than for a time interval.
a threshold which indicates the conditions on the level to be reached for the RAI.
a preferred level of accuracy which indicates the accuracy level of the RAI that the RAI consumer preferred. For example, the preferred level of accuracy may be low, medium, high or highest.

In the case that the near-RT RIC platform may accept the request, e.g., the API event subscription request message, in operation 411, it may transmit a response message (or a success message) to the RAI consumer, such as an API event subscription response message.

In operation 412, the near-RT RIC platform may transmit a message, e.g., an API event notification message to the RAI consumer.

The message may include one or more supported RAI types which may be provided by the RAI producer xApp. The detailed description of the supported RAI types is similar to the supported RAI types as described in operation 301.

The message may further include at least one of the following:
A validity period, that is, the RAI may be valid during the time period.
A confidence, or a confidence value; which may indicate the probability assertion, i.e., confidence in the RAI.
One or more dependent RAI types for the supported RAI type, that is, the one or more dependent RAI types are needed for normal operation of the xApp. For example, dependent RAI type A and dependent RAI type B are needed for RAI type 1.
If the one or more dependent RAI types are included, the message may further include the xApp ID of the RAI producer xApp that could provide the one or more dependent RAI types. In one embodiment, the API ID may be used to indicate the xApp that could provide the one or more dependent RAI types.

Operations 413-416 are similar to operations 313-316 in FIG. 3, and details are omitted here.

FIG. 5 illustrates a method performed by a server, as a producer of RAI according to some embodiments of the present disclosure.

In operation 501, the RAI producer xApp may transmit, to an RIC platform (for example, the RIC platform may be the near-RT RIC platform, or the non-RT RIC platform), a first message(s) indicating at least one supported RAI type (for example, operation 301 as described in FIG. 3); and in operation 502, the RAI producer xApp may generate RAI of a supported RAI type (for example, operation 308 as described in FIG. 3).

In some embodiments, the supported RAI type includes network application or predicted information.

In some embodiments, the first message indicates the at least one supported RAI type, or each first message indicates a single supported RAI type.

In some embodiments, the first message further indicates a dependent RAI type corresponding to the supported RAI type.

In some embodiments, the first message further indicates required data corresponding to the supported RAI type.

In some embodiments, the RAI producer xApp may receive, from the RIC platform or a server as a consumer of RAI, the required data to generate RAI of the supported RAI type (for example, operation 307 as described in FIG. 3).

In some embodiments, the RAI producer xApp may transmit, to the RIC platform, the generated RAI of the supported RAI type (for example, operation 309 as described in FIG. 3).

In some embodiments, the RAI producer xApp may receive, from a server as a consumer of RAI, a second message for RAI of the supported RAI type by an API invocation; generate the RAI of the supported RAI; and transmit, to a server as the consumer of RAI, the generated RAI of the supported RAI.

In some embodiments, a single API may carry the at least one supported RAI type, or each API defines each supported RAI type. In other words, the single API may be used for all of the at least one supported RAI type, or There is a one-to-one correspondence between the API and a supported RAI type.

In some embodiments, the API may further indicate RAI of a dependent RAI type corresponding to the supported RAI type, required data, or both.

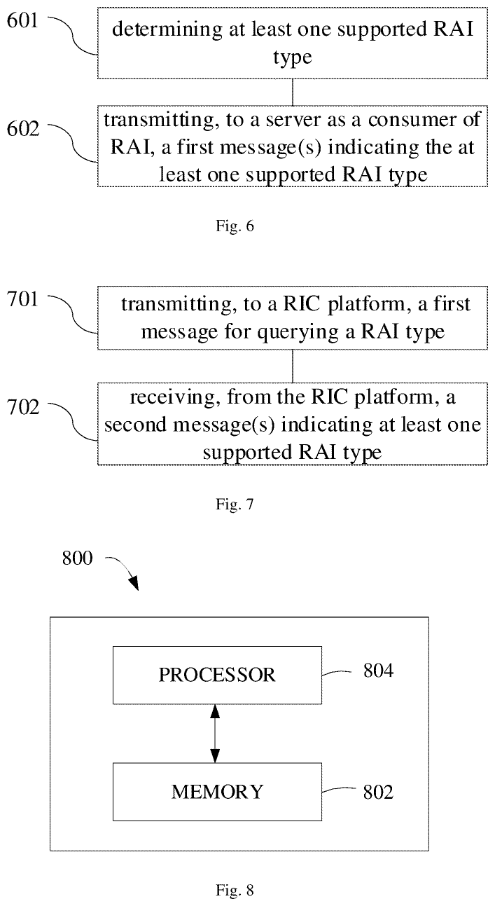

FIG. 6 illustrates a method performed by a RIC platform according to some embodiments of the present disclosure. For example, the RIC platform may be the near-RT RIC platform, or the non-RT RIC platform.

In operation 601, the RIC platform may determine at least one supported RAI type; and in operation 602, the RIC platform may transmit, to a server as a consumer of RAI, a first message(s) indicating the at least one supported RAI type.

In some embodiments, the first message(s) includes information of an API for obtaining the supported RAI type, and further includes any of the following:
A validity period associated with the RAI;
A confidence associated with the RAI; or
An identifier of a server, as a producer of RAI of a dependent RAI type.

In some embodiments, the RIC platform may receive, from a server as a producer of RAI, a second message indicating at least one supported RAI type (for example, operation 301 as described in FIG. 3).

In some embodiments, the second message further indicates a dependent RAI type corresponding to a supported RAI type, required data, or both.

In some embodiments, the RIC platform may transmit, to a server as a producer of RAI, required data to generate RAI of the supported RAI type (for example, operation 307 as described in FIG. 3); and may receive, from the server as a producer of RAI, the generated RAI of the supported RAI type (for example, operation 309 as described in FIG. 3).

In some embodiments, the RIC platform may receive, from the server as a consumer of RAI, a third message including one or more RAI types (for example, operation 310 as described in FIG. 3), and further including any of the following:
Time information associated with the RAI of a RAI type;
A threshold associated with levels to be reached for the RAI of a RAI type;
A level of accuracy associated with the RAI of a RAI type; or
A reporting periodicity associated with a notification of the support RAI type.

In some embodiments, the first message(s) is an API discovery response message or a notification message.

In some embodiments, the RIC platform may receive, from the server as a consumer of RAI, a fourth message requesting for RAI of the supported RAI type by an API invocation (for example, operation 313 as described in FIG. 3); and may transmit, to the server as the consumer of RAI, the RAI of the supported RAI.

FIG. 7 illustrates a method performed by a server, as a consumer of RAI according to some embodiments of the present disclosure.

In operation 701, the server may transmit, to a RIC platform (for example, the RIC platform may be the near-RT RIC platform, or the non-RT RIC platform), a first message for querying a RAI type (for example, operation 310 as described in FIG. 3); and in operation 702, the server may receive, from the RIC platform, a second message(s) indicating at least one supported RAI type (for example, operation 311 as described in FIG. 3).

In some embodiments, the first message is an API discovery request message includes one or more RAI types, and further including any of the following:
Time information associated with the RAI of a RAI type;
A threshold associated with levels to be reached for the RAI of a RAI type;
A level of accuracy associated with the RAI corresponding to the one or more RAI types; or
A reporting periodicity associated with a notification of the support RAI type.

In some embodiments, the second message(s) includes information of an API for obtaining the supported RAI type, and further includes any of the following:
A dependent RAI type of a RAI type;
A validity period associated with the RAI;
A confidence associated with the RAI; or
An identifier of a module that generates RAI for a dependent RAI type.

In some embodiments, the server may transmit, to a server as a producer of RAI or the RIC platform, a third message for RAI of the supported RAI type by an API invocation (for example, operation 314 as described in FIG. 3); and may receive, from the server as the producer of RAI or the RIC platform, the generated RAI of the supported RAI.

FIG. 8 illustrates a simplified block diagram of an apparatus according to some embodiments of the present disclosure.

As shown in FIG. 8, an example of the apparatus 800 may include at least one processor 804 and at least one memory 802 coupled to the processor 804. The apparatus 800 may be an RAI producer xApp, a near-RT RIC platform, a non-RT RIC platform, an E2 node, an RAI consumer, or any other device with similar functions.

Although in this figure, elements such as the at least one memory 802 and processor 804 are described in the singular, the plural is contemplated unless a limitation to the singular is explicitly stated. In some embodiments of the present disclosure, the memory 802 may be a non-volatile memory circuitry or a volatile memory.

In some embodiments of the present disclosure, the apparatus 800 may be the RAI producer xApp, the near-RT RIC platform, the non-RT RIC platform, the E2 node, or the RAI consumer. The memory 802 and the processor 804 may interact with each other so as to perform the operations of the RAI producer xApp, the near-RT RIC platform, the non-RT RIC platform, the E2 node, or the RAI consumer described in any of FIGS. 1-7.

In some embodiments of the present disclosure, the memory may be at least one non-transitory computer-readable medium, and the non-transitory computer-readable medium may have stored thereon computer-executable instructions to cause the processor 804 to implement the method described in any of FIGS. 1-7.

In some embodiments of the present disclosure, the memory 802 may have stored thereon computer-executable instructions to cause the processor 804 to implement the method with respect to the node as described above. For example, the computer-executable instructions, when executed, cause the processor 804 interacting with memory 802 to perform the operations of the node described in any of FIGS. 1-7.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each Fig. are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

What is claimed is:

1-15. (canceled)

16. An apparatus for wireless communication, comprising:
at least one memory; and
at least one processor coupled with the at least one memory and operable to cause the apparatus to:
determine at least one supported radio access network (RAN) analytics information (RAI) type; and
transmit a first message indicating the at least one supported RAI type.

17. The apparatus of claim 16, wherein the first message comprises information of an application programming interface (API) for obtaining the at least one supported RAI type.

18. The apparatus of claim 17, wherein the first message further includes a validity period associated with RAI.

19. The apparatus of claim 17, wherein the first message further includes a confidence value associated with RAI.

20. The apparatus of claim 17, wherein the first message further includes an identifier of a server that produces RAI of a dependent RAI type.

21. The apparatus of claim 16, wherein the at least one processor is operable to cause the apparatus to:
receive a message requesting for RAI of the at least one supported RAI type by an application programming interface (API) invocation; and
transmit the RAI of the at least one supported RAI type.

22. The apparatus of claim 21, wherein a single API carries the at least one supported RAI type.

23. The apparatus of claim 21, wherein one or more APIs define one or more supported RAI types.

24. A method performed by an apparatus, the method comprising:
determining at least one supported radio access network (RAN) analytics information (RAI) type; and
transmitting a first message indicating the at least one supported RAI type.

25. The method of claim 24, wherein the first message comprises information of an application programming interface (API) for obtaining the at least one supported RAI type.

26. The method of claim 25, wherein the first message further includes a validity period associated with RAI.

27. The method of claim 25, wherein the first message further includes a confidence value associated with RAI.

28. The method of claim 25, wherein the first message further includes an identifier of a server that produces RAI of a dependent RAI type.

29. The method of claim 24, further comprising:
receiving a message requesting for RAI of the at least one supported RAI type by an application programming interface (API) invocation; and
transmitting the RAI of the at least one supported RAI.

30. The method of claim 29, wherein a single API carries the at least one supported RAI type.

31. An apparatus for wireless communication, comprising:
at least one memory; and
at least one processor coupled with the at least one memory and operable to cause the apparatus to:
transmit a first message for querying a radio access network (RAN) analytics information (RAI) type; and
receive a second message indicating at least one supported RAI type.

32. The apparatus of claim 31, wherein the at least one processor is operable to cause the apparatus to:
transmit a third message for RAI of the at least one supported RAI type by an application programming interface (API) invocation; and
receive RAI of the at least one supported RAI type.

33. The apparatus of claim 31, wherein the first message is transmitted to a RAN intelligent controller (RIC) platform, and the second message is received from the RIC platform.

34. A method performed by an apparatus, the method comprising:
transmitting a first message for querying a radio access network (RAN) analytics information (RAI) type; and
receiving a second message indicating at least one supported RAI type.

35. The method of claim 34, further comprising:
transmitting a third message for RAI of the at least one supported RAI type by an application programming interface (API) invocation; and
receiving RAI of the at least one supported RAI type.
